(19) United States
(12) Patent Application Publication
(10) Pub. No.: US 2005/0171257 A1
(43) Pub. Date: Aug. 4, 2005

(54) Perfluoroelastomer composition for use in vulcanization and method for making a molded perfluoroelastomer product

(75) Inventor: Katsuhiro Wakui, Tokyo (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/040,882

(22) Filed: Jan. 21, 2005

(30) Foreign Application Priority Data
Feb. 3, 2004 (JP) 2004-026705

(51) Int. Cl. C08K 5/17

(52) U.S. Cl. 524/236; 524/366; 524/544

(57) ABSTRACT

A perfluoroelastomer composition for use in vulcanization, comprising a curable perfluoroelastomer polymer and a fluorochemical solvent (preferably selected from perfluorocarbons, perfluoroamines, perfluoromonoethers and hydrofluoromonoethers) having a boiling point of 50 to 280° C., is provided. The fluorochemical solvent included in the perfluoroelastomer composition may be volatilized while the composition is molded and will not remain in a final molded perfluoroelastomer product. This allows one to provide a perfluoroelastomer product that has reduced emission of ingredients (such as outgas or bleed) therefrom, even when used in harsh environments such as semiconductor processing environments. This composition also provides good workability in the mixing step, and good flowability and moldability in the molding step.

This application claims priority to Japanese Patent Application No. 2004-026705, filed Feb. 3, 2004.

### FIELD OF THE INVENTION

The present invention relates to a perfluoroelastomer composition and a method for making a perfluoroelastomer product which has desired properties and which has reduced emission of ingredients (such as outgas or bleed) therefrom, even when used in harsh environments such as semiconductor processing environments.

### BACKGROUND OF THE INVENTION

Perfluoroelastomers (i.e. elastomeric perfluoropolymers) have excellent chemical resistance, plasma resistance and heat resistance. Perfluoroelastomers have been used as various sealing materials (e.g. O-rings, flange seals, packings, gasket stocks, pump diaphragms, plunger seals, door seals, lip and face seals, gas delivery plate seals, wafer support seals, barrel seals) and as lining materials. Perfluoroelastomers find use, for instance, in the electrical and electronic, aerospace and petroleum industries, which require the materials to be used in harsh environments.

Traditional perfluoroelastomers have certain disadvantages. For instance, it may be difficult to mold them into a perfluoroelastomer product. More particularly, molding of perfluoroelastomers is typically carried out by mixing a curable perfluoroelastomer composition with a reinforcing filler, a curing agent, a curing aid, a crosslinker, an acid acceptor and other additives, by means of rubber mill or the like, followed by molding the mixed materials, i.e. heating them in a mold to effect crosslinking and curing (including a primary press vulcanization at a temperature of about 120 to about 200° C., and a secondary oven vulcanization at a temperature of about 180 to about 300° C.). The curable perfluoroelastomer composition is very hard, however, and is therefore difficult to wind around rolls of a rubber mill. Thus, the curable perfluoroelastomer composition has a disadvantage in its poor workability during the mixing step. Also, during the molding step, the curable perfluoroelastomer composition is difficult to flow into and through the mold, which may often lead to poor quality molding.

Conventional approaches fail in that they may sacrifice the properties desired for an elastomer. Additionally, the elastomers have a tendency to decompose, without volatilizing, at a temperature (e.g. about 370° C.) much higher than the oven vulcanization temperature resulting in bleeding from the elastomer product. Conventional approaches may also involve introducing a relatively large monomer having no rubber elasticity into a polymer, resulting in a perfluoroelastomer having decreased rubber elasticity.

### SUMMARY OF THE INVENTION

There remains a problem in the art that conventional perfluoroelastomer products possess inferior physical properties, or emit ingredients (such as outgas or bleed). Particularly, emission of ingredients may be detrimental in manufacturing electronic devices such as semiconductor devices or liquid crystal panels where any contamination must be avoided.

It is an object of the present invention to obtain a perfluoroelastomer product which has desired properties for a perfluoroelastomer and which has reduced emission of ingredients (such as outgas or bleed) therefrom, even when used in harsh environments such as semiconductor processing environments.

In one aspect, the present invention relates to a perfluoroelastomer composition for use in vulcanization, comprising a curable perfluoroelastomer polymer and a fluorochemical solvent having a boiling point of 50 to 280° C.

A gas generated in the mold may cause a problem that it tends to deteriorate the physical properties (such as tensile strength and the like) of molded product, as well as causing a problem of poor quality molding. Accordingly, conventional perfluoroelastomer compositions avoid solvents capable of being volatilized during or before vulcanization.

Surprisingly, the inventor has found that a perfluoroelastomer product having desired physical properties can be obtained by molding from a curable perfluoroelastomer composition containing a fluorochemical solvent, even though the included fluorochemical solvent is allowed to vaporize during or before vulcanization.

The present invention also relates to a perfluoroelastomer composition for use in vulcanization, consisting essentially of: (a) a curable perfluoroelastomer polymer; (b) a fluorochemical solvent having a boiling point of 50 to 280° C.; (c) a filler selected from fluoropolymers; (d) a curing agent selected from organic peroxides; and (e) a crosslinker selected from polyfunctional unsaturated compounds.

In yet another aspect, the present invention relates to a method for making a molded perfluoroelastomer product, comprising:
(a) mixing a curable perfluoroelastomer polymer with a fluorochemical solvent having a boiling point of 50 to 280° C. and optionally other additives to obtain a curable perfluoroelastomer composition;
(b) placing the curable perfluoroelastomer composition into a mold;
(c) heating the perfluoroelastomer composition to a temperature which is sufficient to volatilize the fluorochemical solvent and which is sufficient to effect curing and crosslinking, and to obtain a molded perfluoroelastomer product.

Preferably, the heating of the perfluoroelastomer composition in step (c) is carried out at a temperature of 140 to 300° C., and more preferably 160 to 260° C.

In another aspect, step (c) comprises a primary (press) vulcanization and a secondary (oven) vulcanization steps. Preferably, the press vulcanization step is carried out, under a pressure of 5 to 25 MPa, at a temperature of 140 to 200° C., and more preferably 160 to 180° C.

Preferably, the oven vulcanization step is carried out, at a temperature of about 180 to about 300° C., and more preferably 200 to 260° C.

In a further aspect, the fluorochemical solvent may have a boiling point of 180 to 250° C., and the fluorochemical solvent is volatilized in a substantial amount during the press vulcanization in step (c). The oven vulcanization can be carried out at a temperature lower than or equal to the boiling point of the fluorochemical solvent, or preferably can be carried out at a temperature above the boiling point of the fluorochemical solvent.

The perfluoroelastomer composition for use in vulcanization of the present invention includes a fluorochemical solvent which is compatible with the curable perfluoroelastomer polymer. When the perfluoroelastomer composition is used to make a molded perfluoroelastomer product, the perfluoroelastomer polymer is sufficiently softened and facilitated to wind around rolls of the rubber mill, which provides good workability during the mixing process. Also, the perfluoroelastomer composition of the present invention can be used to improve the processability and moldability in making a molded perfluoroelastomer product. Further, the fluorochemical solvent included in the perfluoroelastomer composition of the present invention has a boiling temperature of lower than or equal to 280° C., particularly lower than or equal to 250° C. The fluorochemical solvent may be volatilized while the composition is molded and does not remain in a final molded perfluoroelastomer product.

In another aspect, a perfluoroelastomer product is provided which is free from emission of ingredients (such as outgas or bleed) therefrom, while it has retained desired elastomeric properties. In addition, the method of the present invention does not employ any perfluoropolyether or another similar expensive additive, which reduces the cost for making a molded perfluoroelastomer product.

### DETAILED DESCRIPTION OF THE INVENTION

As used herein, the term “curable perfluoroelastomer polymer” refers to an uncured and non-crosslinked, substantially fully fluorinated fluoropolymer which, after cured, can exhibit an elastomeric character. Preferably, the perfluoroelastomer polymer is comprised, in its principle portion, of copolymerized units of at least two perfluorinated monomers, into which a cure site monomer containing a reactive site such as bromine (Br), iodine (I), nitrile (CN) or the like, is copolymerized as its minor portion.

The principle monomers making up the curable perfluoroelastomer polymer preferably include a combination of at least one of perfluoroolefins and at least one of perfluorovinyl ethers.

Examples of the perfluoroolefins include, but not limited to, tetrafluoroethylene, hexafluoropropylene, and a mixture thereof, with tetrafluoroethylene particularly preferred.

The perfluorovinyl ethers typically include perfluoro(alkyl vinyl)ethers and perfluoro(alkoxy vinyl)ethers of the formula (1):
CF₂═CFO(R′_{f}O)ₙ(R″_{f}O)ₘR_{f} (1)
wherein
R′_{f} and R″_{f} are the same or are different linear or branched perfluoroalkylene groups of 2-6 carbon atoms;
m and n are, independently, an integer from 0 to 10; and
R_{f} is a perfluoroalkyl group of 1-6 carbon atoms.

A preferred class of the perfluoro(alkyl vinyl)ethers include compositions of the formula (2):
CF₂═CFO(CF₂CFXO)ₙR_{f} (2)
wherein
X is F or CF₃;
n is 0-5; and
R_{f} is a perfluoroalkyl group of 1-6 carbon atoms.

Perfluoro(alkyl vinyl)ethers include those where, in reference to either formula (1) or (2) above, n is 0 or 1 and R_{f} contains 1-3 carbon atoms. Examples of such perfluoro(alkyl vinyl)ethers include perfluoro(methyl vinyl)ether, perfluoro(ethyl vinyl)ether, and perfluoro(propyl vinyl)ether.

Other useful perfluoro(alkyl vinyl)ether monomers include those compounds of the formula (3):
CF₂═CFO[(CF₂)ₘCF₂CFZO]ₙR_{f} (3)
wherein R_{f} is a perfluoroalkyl group having 1-6 carbon atoms, m is 0 or 1, n is 0-5, and Z is F or CF₃. Preferred members of this class are those in which R_{f} is C₃F₇, m is 0, and n is 1.

Additional perfluoro(alkyl vinyl)ether monomers useful in the invention include those of the formula (4):
CF₂═CFO[(CF₂CFCF₃O)ₙ(CF₂CF₂CF₂O)ₘ(CF₂)ₚ]CₓF₂ₓ₊₁ (4)
wherein m and n are independently an integer from 0 to 10, p is 0-3, and x is 0-5.

Perfluoro(alkoxy vinyl)ethers useful in the invention include those of the formula:
CF₂═CFOCF₂CF(CF₃)O(CF₂O)ₘCₙF₂ₙ₊₁ (5)
wherein n is 1-5, preferably 1, and m is 1-3.

Representative examples of perfluoro(alkoxy vinyl)ethers useful in the invention include CF₂═CFOCF₂OCF₂CF₂CF₃, CF₂═CFOCF₂OCF₃, CF₂═CFO(CF₂)₃OCF₃, and CF₂═CFOCF₂CF₂OCF₃.

Mixtures of perfluoro(alkyl vinyl)ethers and perfluoro(alkoxy vinyl)ethers may also be employed.

In one aspect, the cure site monomer introduced into the curable perfluoroelastomer polymer is capable of participating in a peroxide cure reaction. Generally, the most useful cure site monomer will contain one or more bromine (Br) or iodine (I) groups, but other functional groups that can participate in the cure reaction, such as nitrile (CN) groups, may also be employed.

Examples of preferred Br— or I-containing cure site monomers include, but are not limited to, bromodifluoroethylene, bromotrifluoroethylene, iodotrifluoroethylene, and 4-bromo-3,3,4,4-tetrafluorobutene-1, CF₂═CFOCF₂CF₂Br, CF₂═CFOCF₂CF₂CF₂Br, CF₂═CFOCF₂CF₂CF₂OCF₂CF₂Br.

Preferred CN-containing cure site monomers include the following:
CF₂═CFO(CF₂)ₙCN (6)
CF₂═CFO[CF₂CFCF₃O]ₚCF₂CF(CF₃)CN (7)
CF₂═CF[OCF₂CFCF₃]ₓO(CF₂)ₘCN (8)
where, in reference to formulas 6, 7, and 8, n=2-12; p=0-4; x=1-2; and m=1-4. An example of preferred CN-containing cure site monomer is perfluoro(8-cyano-5-methyl-3,6-dioxa-1 -octene).

In yet a further aspect, the curable perfluoroelastomer polymer used in the invention may be, for example, a terpolymer formed of about 50 to about 85% by mole of CF₂═CF₂, about 15 to about 50% by mole of CF₂═CF(OCF₃) and about 0.2 to about 5% by mole of acure site monomer.

The curable perfluoroelastomer polymer can be prepared by any of the methods known in the art, such as bulk, suspension, solution or emulsion polymerization. For example, the polymerization process can be carried out by free radical polymerization of the monomers alone or as solutions, emulsions, or dispersions in an organic solvent or water. Polymerization in an aqueous emulsion or suspension is often preferred, because of the rapid and nearly complete conversion of monomers, easy removal of the heat of polymerization, and ready isolation of the polymer. Emulsion or suspension polymerization typically involves polymerizing monomers in an aqueous medium in the presence of an inorganic free-radical initiator system, such as ammonium persulfate or potassium permanganate, and surfactant or suspending agent.

The fluorochemical solvent employed in the present invention has a boiling point of higher than or equal to 50° C., preferably higher than or equal to 130° C., and more preferably higher than or equal to 180° C. The solvent employed has a boiling point of lower than or equal to 280° C., preferably lower than or equal to 260° C., and more preferably lower than or equal to 250° C.

If the boiling point of the fluorochemical solvent is too low, the solvent may be volatilized during the mixing step. This may cause poor mixing or poor flow during the subsequent primary (press) vulcanization. Therefore, a fluorochemical solvent having a boiling point of lower than 130° C., in particular lower than 50° C., is not preferred.

On the other hand if the boiling point of the fluorochemical solvent is too high, the solvent may remain in a final molded product obtained after the secondary vulcanization. This may lead to a large quantity of outgas or of bleeding on the surface of the final product when used. Therefore, a fluorochemical solvent having a boiling point of higher than 260° C., in particular higher than 280° C., is also not preferred.

Particularly, when the fluorochemical solvent employed in the present invention has a boiling temperature of 180 to 250° C., the solvent can be volatilized bit by bit, over a wide range of temperature across the primary vulcanization (typically about 140 to about 180° C.) and the secondary vulcanization (typically about 180 to about 260° C.). Thus, use of such a fluorochemical solvent may allow one to obtain a molded product with the desired mechanical properties and shape.

In the present invention, any fluorochemical solvent may be employed, from the classes of: perfluorocarbons, perfluoroamines, perfluoromonoethers, hydrofluoromonoethers, hydrofluorocarbons, hydrochlorofluorocarbons, and mixtures thereof, provided that it has a boiling point of 50 to 280° C. and it is compatible with the curable perfluoroelastomer polymer. For environmental reasons, a non-chlorinated fluorochemical solvent is preferred.

Preferred fluorochemical solvents to employ in the present invention are fluorochemical solvents that assist in mixing the curable perfluoroelastomer polymer with other additives (including a filler such as a perfluoropolymer; a curing agent such as an organic peroxide; a crosslinker such as triallyl isocyanurate) and facilitate uniform dispersion. The fluorochemical solvent employed in the present invention preferably has affinity with both the perfluoroelastomer polymer and at least one of the additives. The fluorochemical solvent employed in the present invention is preferably selected from the classes of: perfluorocarbons, perfluoroamines, perfluoromonoethers, hydrofluoromonoethers, and mixtures thereof.

The class of perfluorocarbon fluorochemical solvents includes, but is not limited to: linear or branched perfluoroalkanes such as, for instance perfluoro-n-octane, perfluoro-isooctane, and perfluorododecane; perfluorocycloalkanes such as, for instance, perfluorocyclohexane; perfluoroaryls such as, for instance, perfluorobenzene and perfluorotoluene. In many instances, preferred solvents are linear or branched perfluoroalkanes having 6 to 16 carbon atoms, given by the formula: CₐF₂ₐ₊₂.

The class of perfluoroamine fluorochemical solvents that may be used in the present invention includes any of primary, secondary and tertiary perfluoroamines, but preferred are tertiary perfluoroamines of the following formula (9): 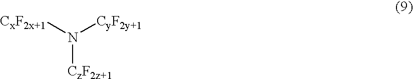
wherein
x+y+z=4 to 17, and
CₓF₂ₓ₊₁, C_{y}F_{2y+1} and C_{z}F_{2z+1} may independently be linear or branched.

Examples of preferred perfluoroamines that may be used in the present invention include, but are not limited to, tri(heptafluoropropyl)amine, tri(nonafluorobutyl)amine, and tri(undecafluoropentyl)amine.

The class of perfluoromonoethers that may be used in the present invention includes any of symmetric or asymmetric perfluoromonoethers. Preferred are asymmetric perfluoromonoethers of the following formula (10):
CₚF₂ₚ₊₁—O—C_{q}F_{2q+1} (10)
wherein
q=1 or 2,
p=3 to 11, and
CₚF₂ₚ₊₁ may be linear or branched.

Typically, the perfluoromonoethers of the above formula have a low viscosity, for instance, of the order of 10 mm²/s.

The class of hydrofluoromonoethers that may be used in the present invention includes any of symmetric or asymmetric hydrofluoromonoethers. Preferred are asymmetric hydrofluoromonoethers having perfluoroalkyl and alkyl groups of the following formula (11):
CₚF₂ₚ₊₁—O—C_{q}H_{2q+1} (11)
wherein
q=1 or 2,
p=3 to 11, and
CₚF₂ₚ₊₁ may be linear or branched.

Typically, the hydrofluoromonoethers of the above formula have a low viscosity, for instance, of the order of 10 mm²/s.

In one embodiment, the fluorochemical solvent may be added to the curable perfluoroelastomer polymer in an amount of 0.5 to 20 parts by weight, preferably 1 to 15 parts by weight, per 100 parts by weight of the curable perfluoroelastomer polymer. Addition of too little fluorochemical solvent may lead to softening of the curable perfluoroelastomer polymer, which in turn might cause a problem in terms of rheological property, workability during the mixing step and flowability during the molding step. On the other hand, adding too much fluorochemical solvent would tend to deteriorate the mechanical properties (such as tensile strength) of a resulting final perfluoroelastomer product.

The perfluoroelastomer composition of the present invention may optionally contain an organic or inorganic reinforcing filler to improve the mechanical properties. In particular, reinforcing fillers may improve, for example, hardness, tensile strength, elongation, or modulus.

Organic fillers may include the class of fluoropolymers including, but not limited to, copolymers of perfluoroolefin and perfluoro(alkyl vinyl)ether (PFA), polytetrafluoroethylene (PTFE), copolymers of tetrafluoroethylene and hexafluoropropylene (FEP), poly(vinylidene fluoride), poly(vinyl fluoride), and poly(chlorotrifluoroethylene). In terms of chemical resistance, plasma resistance and heat resistance, perfluoropolymers such as PFA, PTFE, and FEP are preferred. In terms of affinity with the above perfluoroelastomer polymer, PFA is generally preferred.

The inorganic filler may include fillers, reinforcing materials or pigments, such as, for example, silicon dioxide, aluminum oxide, magnesium oxide, barium sulfate, clay, talc, or carbon black, provided that it is not detrimental to the desired mechanical properties of perfluoroelastomer.

The perfluoroelastomer composition of the present invention may optionally contain a polyfunctional unsaturated compound as a crosslinker (also referred to as co-curative) to form a crosslink between the perfluoroelastomer polymers. Crosslinkers include, but are not limited to, compounds that are activated when heated to a temperature higher than the temperature (about 50° C.) during the mixing step. By activated it is meant that the compounds are susceptible to forming chemical bonds. Such compounds include, for example, triallyl cyanurate, triallyl isocyanurate, tri(methylallyl isocyanurate), tris(diallylamine)-s-triazine, triallyl phosphite, N,N-diallyl acrylamide, hexaallyl phosphoramide, N,N,N′,N′-tetraalkyl-tetraphthalamide, N,N,N′,N′-tetraalkyl malonamide, trivinyl isocyanurate, 2,4,6-trivinyl methylsiloxane, tri(5-norbornene-2-methylene)cyanurate, trimethacryl isocyanurate, xylene-bis(diallyl isocyanurate), divinylbenzene, and m-phenylene-bis-maleimide. Triallyl isocyanurate is particularly useful.

The perfluoroelastomer composition of the present invention may optionally contain a source of oxygen radical as a curing agent (also referred to as curative) needed to effect the reaction of the perfluoroelastomer polymer with the crosslinker. Preferred as the curing agent are organic peroxides, and particularly preferred are organic peroxides that decompose only when heated to a temperature higher than the roll temperature during the mixing step. Such organic peroxides include, for example, 2,5-dimethyl-2,5-bis(t-butylperoxy)hexyne-3,2,5-dimethyl-2,5-di(t-butylperoxy)hexane, α,α′-bis(t-butylperoxy)diisopropyl-benzene), benzoyl peroxide and dicumyl peroxide, and the like. 2,5-dimethyl-2,5-bis(t-butylperoxy)hexyne-3 is particularly useful.

The perfluoroelastomer composition of the present invention may also optionally contain an organic amine or metal oxide as an acid acceptor or additive needed to carry out the above crosslinking reaction under basic conditions. The metal oxide acid acceptor may, for example, include zinc oxide, tin oxide, and calcium oxide. For semiconductor processing applications, however, it is necessary to eliminate any metal ions. The organic amine acid acceptor preferred for the present invention includes, but not limited to, hexamethylene tetramine, 1,8-bis-(dimethyl-aminonaphthalene), and octadecylamine. Hexamethylene tetramine is particularly useful.

The perfluoroelastomer composition of the present invention can be prepared by mixing a curable perfluoroelastomer polymer with a fluorochemical solvent and optionally with other additives (such as a reinforcing filler, crosslinker, curing agent, acid acceptor), using a common mixing means such as rubber mill, Banbury mixer, or kneader. Typically, on a rubber mill, the perfluoroelastomer polymer is masticated and then kneaded with the fluorochemical solvent and other additives. The roll temperature of the rubber mill usually starts at ambient temperature, then rises with the heat spontaneously occurred by the action of shears exerted on the polymers during the mixing process, and is finally settled to a temperature within the range of 100±30° C., in the case where no cooling system is used. Using a cooling system with circulating water or an appropriate heat transfer fluid, the roll temperature can be maintained at a temperature of lower than 50° C. It is advantageous to maintain the roll temperature at a temperature of lower than or equal to 150° C. In some instances, higher temperatures may cause the composition to react.

The materials are preferably added in the order: perfluoroelastomer polymer, fluorochemical solvent, reinforcing agent, crosslinker, acid acceptor, and peroxide (curative).

The perfluoroelastomer composition of the present invention preferably has a compound Mooney viscosity (ML₁₊₁₀@121° C.) of lower than or equal to 85, particularly of 30 to 80. Where the Mooney viscosity is too high, smooth flow into a mold is impeded, which tends to cause short molding, during the primary molding or vulcanization step.

In the present invention, the curable perfluoroelastomer composition for use in vulcanization is placed into a mold and used to obtain a molded perfluoroelastomer product. The preferred method of molding is compression molding. In the present invention, any compression press machine commonly used for rubber vulcanization can be used. Preferably, the compression molding is carried out in two steps: a primary press vulcanization, and a secondary oven vulcanization, although it is possible to omit the secondary vulcanization. Secondary vulcanization may be advantageous in instances where it enhances the mechanical properties of the molded product, such as compression set and tensile strength, as well as improves chemical resistance.

In one aspect, the present invention provides a method for making a molded perfluoroelastomer product, wherein the fluorochemical solvent present in the curable perfluoroelastomer composition is volatilized in the molding step, preferably during the,primary vulcanization step. Fluorochemical solvents, particularly perfluorinated solvents, have high vapor pressure characteristics. Accordingly, fluorochemical solvents, particularly perfluorinated solvents, are easy to vaporize at a temperature below the sovlent's the boiling point. Thus, even when the temperature used for the primary and/or secondary vulcanization is lower than the boiling point of the fluorochemical solvent employed, the fluorochemical solvent can be fully volatilized during the vulcanization.

In yet another aspect of the present invention, it has been found that if the composition comprises more than 15 parts by weight of a fluorochemical solvent per 100 parts by weight of a curable perfluoroelastomer polymer, a resulting molded product after vulcanization of the composition can exhibit deteriorated mechanical properties. It has been found that raising the primary press vulcanization temperature can facilitate volatilization of the fluorochemical solvent, while using a high-temperature of decomposition peroxide allows the reaction to initiate at a higher temperature and affords sufficient time to volatilize the solvent before the reaction is initiated.

The primary press vulcanization is typically carried out under a pressure of about 5 MPa to about 25 MPa, at a temperature of about 140 to 200° C., preferably from 160 to 200° C. The time required for the press vulcanization depends on the press vulcanization temperature, but it is typically between about 5 minutes and one hour. In order to obtain a molded perfluoroelastomer product with desired mechanical properties, it is preferred to use a relatively high press vulcanization temperature so as to fully volatilize the fluorochemical solvent before the reaction is initiated.

During the primary (press) vulcanization, the perfluoroelastomer polymer is cured and crosslinked at the great majority of the cure sites thereof.

After the primary vulcanization, the perfluoroelastomer composition is typically subjected to the secondary vulcanization in an oven at a temperature of about 180 to about 300° C., and preferably of about 200 to about 260° C. The oven vulcanization temperature can be lower than the boiling point of the fluorochemical solvent. However, in order to completely eliminate the possibility of outgas from a final molded product, it is preferred that the oven vulcanization temperature is higher than or equal to the boiling temperature of the fluorochemical solvent. The time required for secondary vulcanization depends on the oven temperature, but it is typically between about 8 to 72 hours, preferably between about 12 to 24 hours. Higher vulcanization temperatures or longer the vulcanization times tend to produce molded products with lower compression set. During the secondary vulcanization, the perfluoroelastomer composition is fully cured and crosslinked. In the case of molding into a thick wall product, it is preferred to carry out the secondary vulcanization step by step so as to avoid foaming.

During the secondary vulcanization, unreacted groups present in trace amounts in the composition are completely reacted, and as a result, emission of any outgas ingredient (including fluorochemical solvent) is completely or nearly completely eliminated.

The perfluoroelastomer products made from the curable perfluoroelastomer compositions of the present invention are useful as various sealing materials (e.g. O-rings, flange seals, packings, gasket stocks, pump diaphragms, plunger seals, door seals, lip and face seals, gas delivery plate seals, wafer support seals, barrel seals) and as lining materials, in industries such as electrical and electronic, aerospace, and petroleum industries, where use of the materials in harsh environments is required, owing to their excellent chemical, plasma and heat-resistances. In particular, the molded perfluoroelastomer products obtainable according to the present invention, which have reduced emission of ingredients (such as outgas or bleed) therefrom, are very useful as sealing materials for use in an apparatus for producing an electronic device such as semiconductor device or liquid crystal panel, for example, seals for chemical vapor deposition (CVD), dry etching, and oxidization and diffusion apparatuses, in which any contamination is to be avoided.

### EXAMPLES

The following examples are given to illustrate the present invention and are not intended to limit the scope of the invention. Unless explicitly indicated otherwise, all parts and percentages are given by weight.

Preparation of Perfluoroelastomer Compositions for Use in Vulcanization

### Comparative Example 1

A perfluoroelastomer composition was prepared by mixing 100 parts by weight of a curable perfluoroelastomer polymer (having perfluoro(methyl vinyl)ether/tetrafluoroethylene molar ratio of 33.7/66.2 (in percent by mole) as measured by ¹⁹F-NMR), with 25 parts by weight of PFA resin powder (as a filler, available from Dyneon L.L.C.), 0.5 part by weight of 2,5-dimethyl-2,5-bis(t-butyl peroxy)hexyne, 2 parts by weight of triallyl isocyanurate, 1 part by weight of hexamethylene tetramine, on a common rubber mill having a final roll temperature of about 100° C. Due to the hardness of the perfluoroelastomer polymer, it exhibited difficulty winding around the roll. The materials could be eventually mixed, but it required extended time (longer than one hour).

### Comparative Example 2

A perfluoroelastomer composition was prepared in the same method as in Comparative Example 1, except that 10 parts by weight of a perfluoropolyether (given by the formula: F(C₃F₆O)ₙC₂F₅, and having an average molecular weight of about 8,400) was further added to and mixed with 100 parts by weight of the curable perfluoroelastomer polymer. The perfluoroelastomer compositon was mixed in about 15 minutes.

### Example 1

A perfluoroelastomer composition was prepared in the same method as in Comparative Example 1, except that 1 part by weight of tri(undecafluoropentyl)amine (a fluorochemical solvent having a boiling temperature of 215° C.) was further added to and mixed with 100 parts by weight of the curable perfluoroelastomer polymer. The perfluoroelastomer polymer was softened and successfully mixed with the other materials in about 30 minutes.

### Example 2

A perfluoroelastomer composition was prepared in the same method as in Example 1, except that the amount of tri(undecafluoropentyl)amine was increased to 10 parts by weight per 100 parts by weight of the curable perfluoroelastomer polymer. The perfluoroelastomer polymer was softened well, and it was mixed in about 15 minutes.

### Example 3

A perfluoroelastomer composition was prepared in the same method as in Example 1, except that the amount of tri(undecafluoropentyl)amine was increased to 15 parts by weight per 100 parts by weight of the curable perfluoroelastomer polymer. The perfluoroelastomer polymer was softened well, and it was mixed in about 15 minutes.

Measurement of Compound Mooney Viscosity

According to Japanese Industrial Standards (JIS) K6300, Mooney viscosity was measured for the compositions prepared in Examples 1 to 3 and Comparative Examples 1 and 2, using Monsanto Mooney MV2000 viscometer. In the measurement of Mooney viscosity (ML₁₊₁₀@121° C.), an L-type rotor is used, with the test temperature set to 121° C., and with the preheating time and rotor rotation time set to 1 and 10 minutes, respectively. The results are shown in Table 1.

TABLE 1
Perfluoroelastomer Compositions for Use in Vulcanization and Physical Properties thereof

| | Ex. 1 | Ex. 2 | Ex. 3 | Comp. Ex. 1 | Comp. Ex. 2 |
|---|---|---|---|---|---|
| Curable perfluoro-elastomer | 100 | 100 | 100 | 100 | 100 |
| polymer | | | | | |
| PFA resin powder | 25 | 25 | 25 | 25 | 25 |
| Triallyl isocyanurate | 2 | 2 | 2 | 2 | 2 |
| 2,5-dimethyl-2,5-bis (t- | 0.5 | 0.5 | 0.5 | 0.5 | 0.5 |
| butylperoxy)hexyne | | | | | |
| Hexamethylene tetramine | 1 | 1 | 1 | 1 | 1 |
| Tri(undecafluoropentyl) amine | 1 | 10 | 15 | — | — |
| Perfluoropolyether | — | — | — | — | 10 |

Workability in mixing

| | | | | |
|---|---|---|---|---|
| Good | Excellent | Excellent | Bad | Excellent |

Compound Mooney Viscosity

| | | | | | |
|---|---|---|---|---|---|
| ML₁₊₁₀ @121° C. | 85 | 65 | 53 | 90 | 77 |

The compositions of Examples 1 to 3 and Comparative Example 2 exhibited acceptable values of Mooney viscosity that were lower than or equal to 85, whereas the composition of Comparative Example 1 exhibited a high Mooney viscosity of 90. In contrast to the composition of Comparative Example 1 showing poor workability in mixing and poor flowability in molding, improved workability and flowability were actually seen for the compositions of Examples 1 to 3. Particularly, for the compositions of Examples 2 and 3, excellent workability in mixing and flowability in molding were seen.

Molding of Perfluoroelastomer

Each of the curable perfluoroelastomer compositions of Examples 1 to 3 and Comparative Examples 1 and 2 was placed into a mold equipped within a compression press, for making one of various test specimens (having ring, sheet and cylindrical-shapes), and subjected to press vulcanization, under a pressure of about 20 MPa, for 15 minutes at 170° C. Each composition was then subjected to oven vulcanization for 16 hours at 230° C.

Physical Properties of Molded Perfluoroelastomer Products

The test specimens obtained by molding from each of the compositions of Examples 1 to 3 and Comparative Examples 1 and 2 were tested to determine the following physical properties.

Durometer Hardness

According to JIS K6253, hardness H_{A} was measured with a type A durometer, and determined from the depth forced by an indenter point biased with a spring onto a surface of the specimen. The measurement was carried out for each specimen made in the Examples and Comparative Examples. The results are shown in Table 2.

Tensile Strength, Elongation (%) and 100% Modulus

According to JIS K625 1, each of the five specimens made in the Examples and Comparative Examples were tested for tensile strength T_{B} (in MPa), elongation E_{B} (%), and 100% modulus M₁₀₀ (in MPa). The median of the five values were determined and the results are shown in Table 2.

Compression Set

According to JIS K6262, each specimen made in the Examples and Comparative Examples were tested for compression set Cₛ (%) at a test temperature of 200° C. and a test time of 70 hours. The results are shown in Table 2.

TABLE 2
Physical Properties of Molded Perfluoroelastomer Products

| | | | | |
|---|---|---|---|---|
| Ex. 1 | Ex. 2 | Ex. 3 | Comp. Ex. 1 | Comp. Ex. 2 |

Normal State Properties (Primary: 170° C./15 min,
Secondary: 230° C./16 hrs)

| | | | | | |
|---|---|---|---|---|---|
| Hardness, | 78 | 78 | 77 | 77 | 78 |
| Duro A | | | | | |
| Tensile | 14.4 | 13.8 | 11.8 | 14.0 | 12.4 |
| strength, MPa | | | | | |
| Elongation, % | 220 | 200 | 200 | 240 | 200 |
| 100% modulus | 6.11 | 5.66 | 5.63 | 6.10 | 6.65 |
| Appearance | No | No | No | No | Striking |
| | problem | problem | problem | problem | bleed |

Compression set (200° C./70 hrs)

| | | | | | |
|---|---|---|---|---|---|
| % | 42 | 43 | 44 | 43 | 52 |

As seen from Table 2, the molded products from the compositions of Examples 1 to 3 and Comparative Examples 1 and 2 exhibited similar mechanical properties. The molded products from the compositions of Examples 1 to 3, as well as from the composition of Comparative Example 1, had a good compression set and no problem on their appearance, whereas the molded product from the composition of Comparative Example 2 had a higher compression set and resulted in striking bleed.

1. A perfluoroelastomer composition comprising a curable perfluoroelastomer polymer and a fluorochemical solvent having a boiling point of 50 to 280° C.

2. The composition of claim 1, wherein the fluorochemical solvent has a boiling point of 180 to 250° C.

3. The composition of claim 1, wherein the fluorochemical solvent is selected from perfluorocarbons, perfluoroamines, perfluoromonoethers, hydrofluoromonoethers, and combinations thereof.

4. The composition of claim 1, wherein the fluorochemical solvent is selected from:
linear or branched perfluoroalkanes having 6 to 16 carbon atoms given by the formula: CₐF₂ₐ;
asymmetric perfluoromonoethers of the following formula:
CₚF₂ₚ₊₁—O—C_{q}F_{2q+1}
wherein q=1 or 2, p=3 to 11, and CₚF₂ₚ₊₁ may be linear or branched;
asymmetric hydrofluoromonoethers of the following formula:
CₚF₂ₚ₊₁—O—C_{q}H_{2q+1}
wherein q=1 or 2, p=3 to 11, and CₚF₂ₚ₊₁ may be linear or branched;
tertiary perfluoroamines of the following formula: 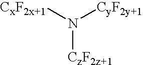
wherein x+y+z=4 to 17, and CₓF₂ₓ₊₁, C_{y}F_{2y+1} and C_{z}F_{2z+1} may independently be linear or branched; and
combinations thereof.

5. The composition of claim 1, wherein the composition comprises 1 to 20 parts by weight of said fluorochemical solvent per 100 parts by weight of the curable perfluoroelastomer polymer.

6. A perfluoroelastomer composition, consisting essentially of: (a) a curable perfluoroelastomer polymer; (b) a fluorochemical solvent having a boiling point of 50 to 280° C.;
(c) a filler selected from fluoropolymers; (d) a curing agent selected from organic peroxides; and
(e) a crosslinking agent selected from polyfunctional unsaturated compounds.

7. A method for making a molded perfluoroelastomer product, comprising:
(a) mixing a curable perfluoroelastomer polymer with a fluorochemical solvent having a boiling point of 50 to 280° C.;
(b) placing the curable perfluoroelastomer composition into a mold;
(c) heating the perfluoroelastomer composition to a temperature sufficient to volatilize the fluorochemical solvent and to effect curing and crosslinking.

8. The method of claim 7, wherein the fluorochemical solvent has a boiling point of 180 to 250° C.

9. The composition of claim 7, wherein the fluorochemical solvent is selected from perfluorocarbons, perfluoroamines, perfluoromonoethers, hydrofluoromonoethers, and combinations thereof.
